(19) United States
(12) Patent Application Publication
(10) Pub. No.: US 2023/0095145 A1
(43) Pub. Date: Mar. 30, 2023

(54) PANS FOR BAKING AND FOOD STORAGE

(71) Applicant: Hilma Campbell, Jamaica, NY (US)

(72) Inventor: Hilma Campbell, Jamaica, NY (US)

(21) Appl. No.: 17/484,151

(22) Filed: Sep. 24, 2021

(51) Int. Cl. B65D 43/02; A47J 37/01; A47J 36/02

(52) U.S. Cl. CPC B65D 43/0214; A47J 37/01; A47J 36/02

(57) ABSTRACT

Baking pans are designed to provide users with the ability to bake food, while also covering and protecting the food from insects and other pests. The pans are preferably used as bakeware in oven baking but can also be used for other cooking. A lid can be applied to the base to cover food during baking and storage. The lid is preferably made of silicone or a similar polymer that is durable and heat resistant. The lid fits over the top of the pan base and can be fastened to the base using a latch mechanism. The latch mechanism can function as a latch and handle. The latch enables the lid to be snapped on and secured to the base.

### CROSS-REFERENCE TO RELATED APPLICATIONS

This is a Nonprovisional Utility U.S. patent application under 37 CFR 1.53(b).

### BACKGROUND OF THE INVENTION

### 1. Field of the Invention

The present invention relates generally to pans used in baking and cooking. More particularly, the present invention relates to pans with lids for baking and food storage.

### 2. Description of Related Art

Current bakeware pans are effective in oven baking but are not useful for food storage. Bakeware users are often required to use disposable foil or wrap to cover and protect the top of baking pans, creating unnecessary waste. Further, bakeware is often difficult to transport because it lacks sufficient handles. There is a need in the field of bakeware for a product with a reusable lid that provides convenience of storage, and decreases the waste of often-used items for covers such as foil.

### SUMMARY OF THE INVENTION

Baking pan apparatuses are designed to provide users with the ability to bake food, while also covering and protecting the food from insects and other pests. The pans are preferably used as bakeware in oven baking but can also be used for other cooking. The pan base can be rectangular shaped and is preferably comprised of metal or metal alloys. A lid can be applied to the base to cover food during baking and storage. The lid is preferably comprised of silicone or a similar polymer that is durable and heat resistant. The lid fits over the top of the pan base and can be fastened to the base using a latch mechanism. The latch mechanism can function as a latch and handle. The latch enables the lid to be snapped on and secured to the base. Pan embodiments can be oval-shaped, circular, triangular, rectangular, square, etc.

Pans can include one or more latch mechanisms, one or more latch bases, and one or more latch handles. The latch handles are attached to the latch bases. A top section of the latch handle can snap on and fit securely over the lid. The latch handle also enables a user to readily pick up and transport the pan. Further, the pans can include date dials and/or month dials for setting and adjusting the day when storing food. Alternatively, a date dial can be a single component configured to set the day, month, and year.

These and other features and advantages will be apparent from reading of the following detailed description and review of the associated drawings. It is to be understood that both the forgoing general description and the following detailed description are explanatory and do not restrict aspects as claimed.

### BRIEF DESCRIPTION OF THE DRAWINGS

FIG. 1 illustrates a perspective view of a rectangular pan apparatus.

FIG. 2 illustrates a perspective view of an oval pan apparatus.

FIG. 3 illustrates a front view of an oval pan apparatus.

FIG. 4 illustrates a side view of an oval pan apparatus.

FIG. 5 illustrates a top view of an oval pan apparatus.

### DETAILED DESCRIPTION OF EMBODIMENTS

The following descriptions relate principally to preferred embodiments while a few alternative embodiments may also be referenced on occasion, although it should be understood that many other alternative embodiments would also fall within the scope of the invention. The embodiments disclosed are not to be construed as describing limits to the invention, whereas the broader scope of the invention should instead be considered with reference to the claims, which may be now appended or may later be added or amended in this or related applications. Unless indicated otherwise, it is to be understood that terms used in these descriptions generally have the same meanings as those that would be understood by persons of ordinary skill in the art. It should also be understood that terms used are generally intended to have the ordinary meanings that would be understood within the context of the related art, and they generally should not be restricted to formal or ideal definitions, conceptually encompassing equivalents, unless and only to the extent that a particular context clearly requires otherwise.

For purposes of these descriptions, a few wording simplifications should also be understood as universal, except to the extent otherwise clarified in a particular context either in the specification or in particular claims. The use of the term “or” should be understood as referring to alternatives, although it is generally used to mean “and/or” unless explicitly indicated to refer to alternatives only, or unless the alternatives are inherently mutually exclusive. Furthermore, unless explicitly dictated by the language, the term “and” may be interpreted as “or” in some instances. When referencing values, the term “about” may be used to indicate an approximate value, generally one that could be read as being that value plus or minus half of the value. “A” or “an” and the like may mean one or more, unless clearly indicated otherwise. Such “one or more” meanings are most especially intended when references are made in conjunction with open-ended words such as “having,” “comprising” or “including.” Likewise, “another” object may mean at least a second object or more. Thus, in the context of this specification, the term “comprising” is used in an inclusive sense and thus should be understood as meaning “including, but not limited to.” As used herein, the use of “may” or “may be” indicates that a modified term is appropriate, capable, or suitable for an indicated capacity, function, or usage, while considering that in some circumstances the modified term may sometimes not be appropriate, capable, or suitable. “Plurality” is defined as more than one when used to describe a quantity in the specification and claims.

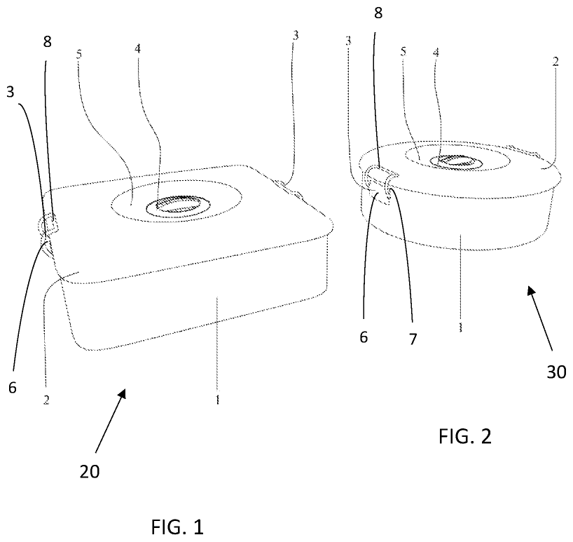

FIG. 1 illustrates a perspective view of a rectangular pan 20 apparatus. The pan 20 is preferably used as bakeware in oven baking but can also be used in other cooking. The pan base 1 can be rectangular shaped and is preferably comprised of metal or metal alloys. For example, the pan base 1 can be square (rectangular) shaped and comprised of aluminum or an aluminum alloy. A lid 2 can be applied to the base 1 to cover food during baking and storage. The lid 2 is preferably comprised of silicone (polysiloxane) or a similar polymer that is durable and heat resistant. The lid 2 fits over the top of the pan base 1 and can be fastened to the base 1 using a latch mechanism 3. The latch mechanism 3 is preferably comprised of metal and can function as a latch and handle. The latch 3 enables the lid 2 to be snapped on and secured to the base 1. Pan embodiments can include one or more latches. In this example, the rectangular pan 20 includes a plurality of latches 3.

Further, the rectangular pan 20 can include a date (day) dial 4 for setting and adjusting the day when storing food. The day dial 4 is preferably located on top of the lid 2 which enables a user to set a day during food storage. Users can readily view the day dial 4 to determine how long the food has been stored. In addition, the rectangular pan 20 can include a month dial 5 for setting and adjusting the month when storing food. The month dial 5 is preferably located on top of the lid 2 which enables a user to set a month during food storage. Alternatively, a date dial 4 can be a single component configured to set the day, month, and year.

FIG. 2 illustrates a perspective view of a round circular (oval) pan 30 apparatus. The round pan 30 functions in a similar manner to the rectangular pan 20. The oval shaped pan 30 is preferably used as bakeware in oven baking but can also be used for other cooking. The oval pan 30 includes a cylindrical (circular) pan base 1, lid 2, one or more latch mechanisms (latches) 3, one or more latch bases 6, and one or more latch handles 7. In this example, the oval pan 30 includes a plurality of latches 3. As shown, the latch base 6 is affixed to the base 1 of the pan 30. The latch handle 7 is attached (operatively connected) to the latch base 6. A top section 8 of the latch handle can snap on and fit securely over the lid 2. The latch handle 7 also enables a user to readily pick up and transport the pan 30. Further, the oval pan 30 can include a date dial 4 and/or a month dial 5. Other shapes of pans besides rectangular and oval shaped can be employed that also utilize the aforementioned components. For example, pan embodiments can be oval-shaped, circular (same radius all around), triangular, rectangular, square, etc.

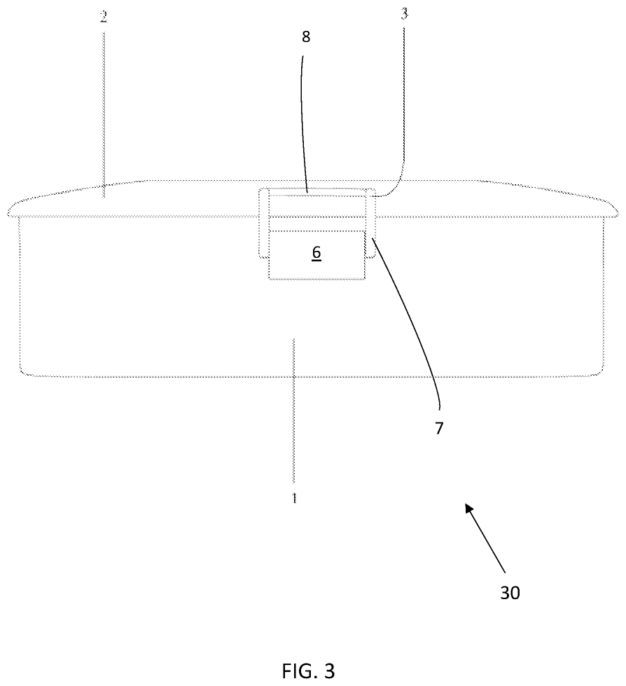

FIG. 3 illustrates a front view of an oval pan 30 embodiment. As shown, the lid 2 fits over the top of the pan base 1 and can be fastened to the base 1 using a latch mechanism 3. The pans 20, 30 can be made with bases 1 of various depths. For example, the depth of the base 1 can be three inches, which is one inch deeper than average bakeware. The base 1 depth can be two inches, 2.5 inches, 3.5 inches, four inches, etc.

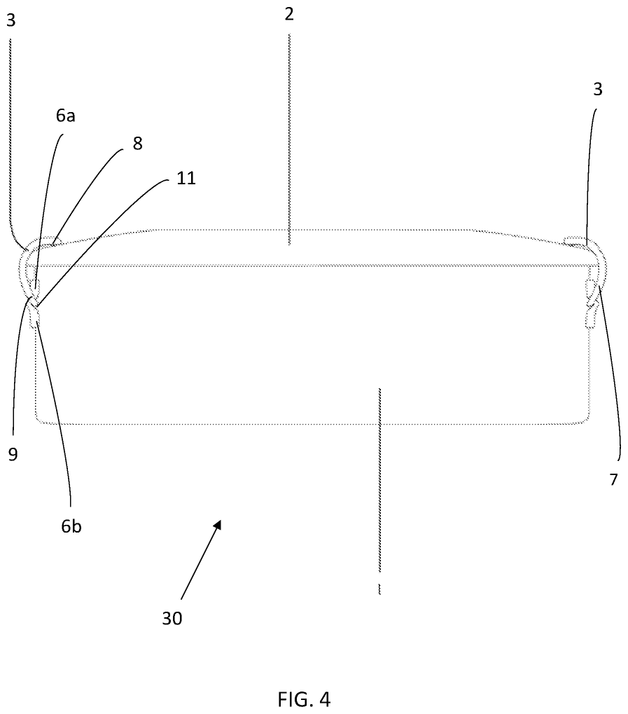

FIG. 4 illustrates a side view of an oval pan 30 embodiment. As shown, the latch handles 7 are attached (operatively connected) to the latch bases 6. In this example, the latch base 6 is shaped (curved) to create a gap 11 between the latch base 6 and the pan base 1. The gap 11 enables a bottom section 9 of the latch handle 7 to fit between the latch base 6 and pan base 1. A top section 6a and a bottom section 6b of the latch base 6 are affixed to the pan base 1 to secure the latch handle 7. The top sections 8 of the latch handles 7 can snap on and fit securely over the lid 2.

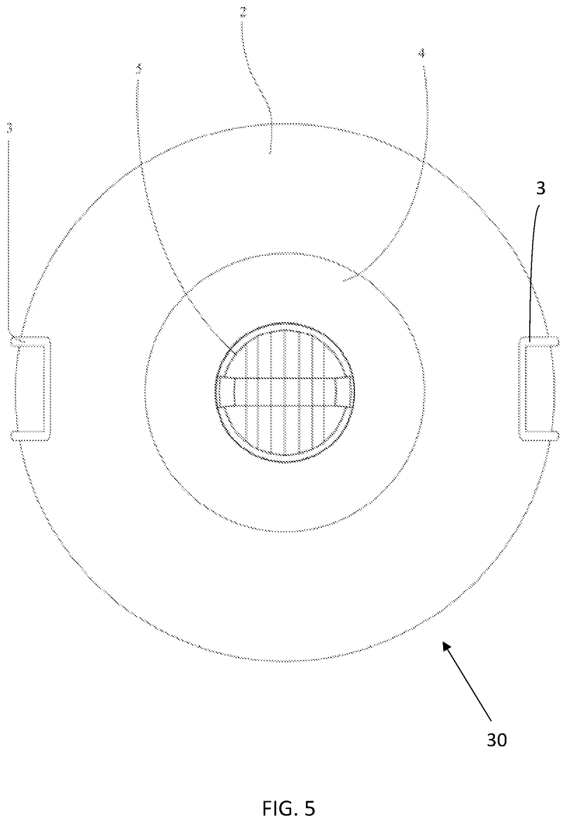

FIG. 5 illustrates a top view of an oval pan 30 embodiment. The round pan 30 can include a date (day) dial 4 for setting and adjusting the day when storing food. The day dial 4 is preferably located on top of the lid 2 which enables a user to set a day during food storage. Users can readily view the day dial 4 to determine how long the food has been stored. In addition, the round pan 30 can include a month dial 5 for setting and adjusting the month when storing food. The month dial 5 is preferably located on top of the lid 2 which enables a user to set a day during food storage. Alternatively, a date dial 4 can be a single component configured to set the day, month, and year.

1. A pan apparatus comprising:
a. a pan base comprising at least one latch;
b. wherein the at least one latch comprises a latch base and a latch handle;
c. wherein the latch base is affixed to the pan base;
d. wherein the latch handle is operatively connected to the latch base;
e. a lid; and
f. wherein the latch handle fits over the lid and secures the lid to the pan base.

2. The apparatus of claim 1, further comprising a day dial.

3. The apparatus of claim 1, further comprising a month dial.

4. The apparatus of claim 1, wherein the pan base and the lid are rectangular shaped.

5. The apparatus of claim 1, wherein the pan base and the lid are oval shaped.

6. The apparatus of claim 1, wherein the pan base comprises metal.

7. The apparatus of claim 6, wherein the metal includes aluminum.

8. The apparatus of claim 1, wherein the lid comprises a polymer.

9. The apparatus of claim 8, wherein the polymer includes silicone.

10. The apparatus of claim 1, wherein the pan apparatus comprises bakeware.

11. The apparatus of claim 1, wherein the latch handle comprises a snap fit mechanism to secure the lid to the pan base.

12. A pan apparatus comprising:
a. a pan base comprising at least one latch;
b. wherein the at least one latch comprises a latch base and a latch handle;
c. wherein the latch base is affixed to the pan base;
d. wherein the latch handle comprises a top section and a bottom section;
e. wherein the bottom section of the latch handle is operatively connected to the latch base;
f. a lid; and
g. wherein the top section of the latch handle fits over the lid and secures the lid to the pan base.

13. The apparatus of claim 12, further comprising a day dial.

14. The apparatus of claim 12, further comprising a month dial.

15. The apparatus of claim 12, wherein the pan base and the lid are rectangular shaped.

16. The apparatus of claim 12, wherein the pan base and the lid are oval shaped.

17. The apparatus of claim 12, wherein the pan base comprises aluminum.

18. The apparatus of claim 12, wherein the lid comprises silicone.

19. The apparatus of claim 12, wherein the pan apparatus comprises bakeware.

20. A bakeware pan apparatus comprising:
a. a metallic pan base comprising at least one latch;
b. wherein the at least one latch comprises a latch base and a latch handle;
c. wherein the latch base comprises a top section and a bottom section;
d. wherein the latch base is curved, creating a gap between the latch base and the pan base;
e. wherein the top section and the bottom section of the latch base are affixed to the pan base;
f. wherein the latch handle comprises a top section and a bottom section;
g. wherein the bottom section of the latch handle fits in the gap between the latch base and the pan base;
h. a lid comprising silicone; and
i. wherein the top section of the latch handle fits over the lid and secures the lid to the pan base.
